(19) United States
(12) Patent Application Publication
(10) Pub. No.: US 2024/0260096 A1
(43) Pub. Date: Aug. 1, 2024

(54) METHOD FOR ESTABLISHING A DATA CONNECTION BETWEEN APPARATUSES AND DEVICE FOR CARRYING OUT THE METHOD

(71) Applicant: Erbe Elektromedizin GmbH, Tuebingen (DE)

(72) Inventor: Bjoern SEITZ, Pfullingen (DE)

(21) Appl. No.: 18/413,976

(22) Filed: Jan. 16, 2024

(30) Foreign Application Priority Data
Jan. 30, 2023 (EP) 23154018.8

(51) Int. Cl. H04W 76/10

(52) U.S. Cl. CPC H04W 76/10

(57) ABSTRACT

A system allowing automatic pairing of different apparatuses within different operation environments. The pairing is carried out based on signal strength or indoor navigation (e.g. Bluetooth). It is detected whether a communication partner, i.e. another apparatus, is present in a distance within a predefined radius (S1) from any other apparatus or from a central apparatus. During the detection the pairing is initiated automatically by (UUID) or certificate exchange without additional interaction by the user or with simple confirmation by the user.

This application claims priority to European Patent Application No. 23154018.8, filed Jan. 30, 2023, the entirety of which is incorporated by reference herein.

Described herein are methods for establishing a data connection between apparatuses as well as a system consisting of multiple apparatuses, wherein a data connection can be established between the apparatuses. Particularly, the apparatuses of the apparatus system can form a subnet within a general data transmission net.

Such apparatus systems are used particularly in hospital environments or other operation environments, e.g. in operation rooms in immobile buildings or also in temporary installations.

It is frequently desired to connect apparatuses that are to be used in an operation room or in another operation environment with one another as well as—where applicable—also with a superordinate network, via which the apparatuses can exchange data among each another or with other resources.

For this purpose, US 2019/0200844 A1 describes apparatuses to be used in an operation environment that are able to determine their distances to one another by means of Bluetooth technology. In addition, the apparatuses can be coupled with instruments via Bluetooth. This document describes in addition the creation of a mapping of the apparatuses by means of mutual triangulation.

US 2022/0238209 A1 also describes the use of a radio network with short range, such as Bluetooth, in an operation environment as well as also the integration of this network into a network with larger range.

EP 2 826 158 A1 describes the registration in a wireless local network by means of Near Field Communication (NFC).

Additional prior art is apparent from EP 2 126 854 A2, U.S. Pat. No. 8,165,102 B1 as well as EP 2 753 233 A1.

It is the object of embodiments of the invention to provide a simple method for networking of multiple apparatuses with one another within an operation environment. In addition, the method shall be applicable in a manner being as safe as possible. It is aimed at limiting the networking to the operation environment.

In addition, it is the object of embodiments of the invention to provide an apparatus system fulfilling the object mentioned above.

These objects are solved by means of the method according to claim 1 and the apparatus system according to claim 10.

Methods disclosed herein are based on apparatuses, which can be arranged in an operation environment and which comprise at least one communication device suitable for distance measurement in each case. The at least one communication device can comprise a first wireless communication device having a first range as well as optionally a second wired or wireless communication device having a second range being different from the first range, particularly exceeding the first range. The first range is preferably limited, further preferably short. A short range thereby means a range having a dimension of an operation environment and, for example, can be in general approximately 10 m to 100 m. A general range means a range in an environment without transmission interfering objects (free-field range). Due to the short range, the first communication devices are configured and usable to determine the distance between the apparatuses. For a distance determination the field strength of a wirelessly transmitted signal at the receiving apparatus can be used, for example.

According to an embodiment, the first communication device is used for determination of the distance between the apparatuses. If the determined distance is below a first threshold, the establishment of a communication connection between the apparatuses and their integration in a network is enabled. For example, the communication connection is established by means of the first, however preferably by means of the other, second communication device, i.e. the clearance for integration of the second communication device into the network is given. This network can be a subnetwork within the general network. While the subnetwork comprises only the apparatuses of the operation environment, the general network can comprise a multiplicity of additional devices, apparatuses and participants.

The clearance can mean the direct establishment of the communication connection between the apparatuses for which the clearance was given. It is, however, also possible to make the integration of the respective apparatus into the subnetwork dependent on the compliance of additional requirements after clearance of the establishment of the communication connection. For this purpose, the compliance of at least one additional requirement is checked and the communication connection is only established after compliance of these additional requirements. Such additional requirements can be, for example, the positioning of the apparatuses in a specific angle relative to a selected apparatus, the manual clearance of the establishment of the connection or many others besides.

The (sub-) network created or used by the second communication devices operates preferably according to a manufacturer-independent standard, such as SDC (service orientated device communication) and can be realized in a wired or wireless manner, e.g. in the context of an LAN (Local Area Network) or WLAN (Wireless Local Area Network) or WIFI.

The clearance of the establishment of a communication connection to this network is given if the distance of the observed apparatuses relative to one another is below a first threshold. This threshold is preferably remarkably lower than the maximum range of the first communication device with short range. In doing so, the threshold is not defined by the range of the first communication device, but is a preset defined value. This value is preferably in the range of one or a few meters.

It is possible to non-variably preset this value for the first communication devices. Alternatively, it is possible to display this threshold on a user interface of at least one of the apparatuses and to vary it by an input possibility. For this purpose, at least one apparatus of the apparatus system is provided with a display and input device as well as with a control, which is configured to adjust the threshold according to the inputs. Alternatively, a service interface can be provided, which is configured so that only qualified service personnel is able to modify the preset threshold. In addition, it is possible to define the thresholds for apparatuses to be connected individually for the apparatuses. For example, a teach-in method can be used. For example, the apparatuses can be arranged in a specific distance and/or angle to one another and where applicable indicated on the user interface of one of the involved apparatuses. A set button can be provided by the actuation of which one or multiple apparatuses can be selected and the actual distance and/or angle is set as valid threshold.

It is possible to arrange one of the apparatuses immovably in order to form an immovable reference point, so that the distance of every other apparatus to this immovable reference point is measured. The fixed reference point can be arranged, for example, directly on the operation site, e.g. in a selected apparatus, or also at the operating table or at another site immovable relative to the building.

The first communication devices of the apparatuses can serve to exchange certificates and/or universal apparatus identifiers (UUID) by which the apparatuses subsequently communicate via the second communication devices among each another and/or with an external other network. The certificate exchange or UUID-exchange between the apparatuses is carried out according to the method of the invention already when the distance of the apparatuses among each another is below the first threshold (whereby it can be provided that additional requirements have to be fulfilled, such as a manual clearance). In other words, if the apparatuses are brought together to a minimum distance, they first couple with one another for the certificate exchange (and/or the UUID-exchange) and then form a local network by a suitable protocol, e.g. SDC.

It is possible to define a second threshold that is equal or larger than the first threshold. The apparatuses can be configured to terminate the communication connection within the operation environment specific network, as soon as the second threshold is exceeded. The involved apparatuses are then taken out of the subnetwork of the operation environment. In this manner apparatuses that are moved out of the operation environment can be automatically taken out of the coupling with the other apparatuses of the operation environment. The connection of the apparatuses to the general network can be terminated as well or, as preferred, can also be maintained.

In so far, the embodiment provides a comfortable handling of apparatuses that couple completely automatically or semi-automatically with each other as soon as a minimum distance from each other is undercut and that decouple automatically as soon as they exceed a maximum distance.

In addition to the distance information, the direction information between apparatuses can be evaluated. This is particularly expedient, if one of the apparatuses is immovable, e.g. arranged at the operating table and as apparatus coupler centrally takes over the function of apparatus coupling. Particularly, it can be provided that the apparatus coupler determines the direction to the respective other apparatus and carries out a coupling only in case not only the minimum distance is undercut, but in addition also the apparatus to be coupled is within an angular range (e.g., spherical distance and direction) defined by the apparatus coupler. This allows a better distinction between apparatuses being part of the operation environment and apparatuses of a neighboring operation environment.

By means of the method in accordance with embodiments of the invention, not only apparatuses can be integrated into the communication (e.g. via SDC) of the operation environment, but also persons. For example, different surgeons can have different preferences for the settings of the apparatuses to be used. If the respective surgeon carries a device, such as a mobile device, e.g. a tablet or another device configured for Bluetooth, this device can send an identification code to the apparatuses via the first communication device (e.g. Bluetooth), which then forwards the identification code to a hospital network via the second communication device. The hospital network can comprise a database, for example, in which the individual setting data of different surgeons are stored, such as effect, effect strength, etc. These individual setting data are then distributed in the network via the second communication device. These settings do not have to necessarily be provided on a central database. Also, a local storage on a communication participant is possible. The apparatuses can then take over these preferred settings. In this manner each surgeon finds his/her preferred settings in each operation environment of the system without having to set the apparatuses separately in each case.

Further details of advantageous embodiments of the invention are subject matter of the description, the claims or the drawing. The drawing shows:

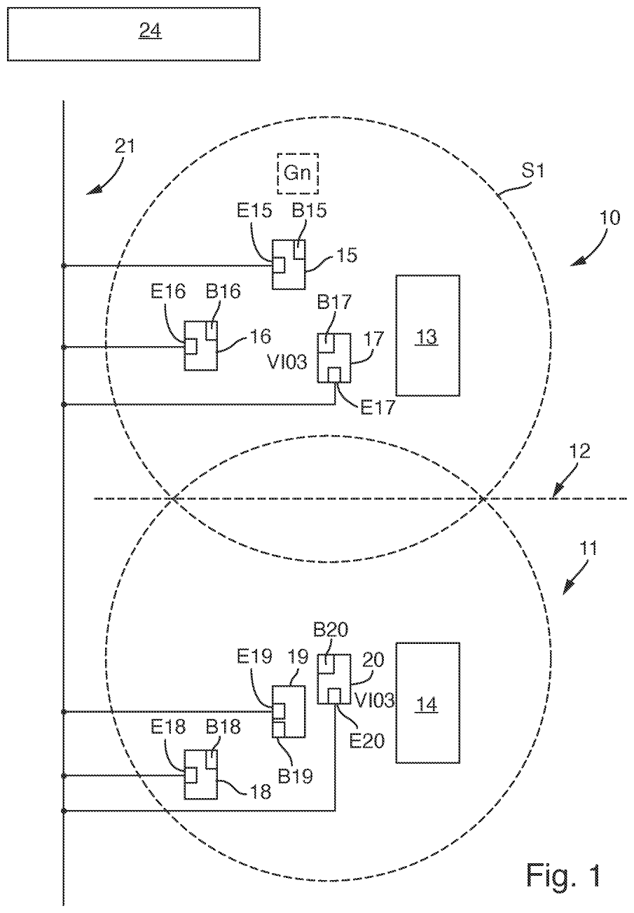

FIG. 1 a first system according to the invention in a first simple embodiment,

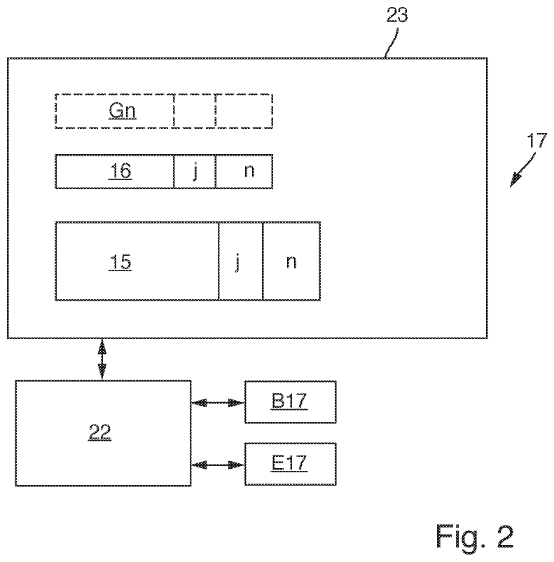

FIG. 2 parts of the basic structure of an apparatus being part of the system,

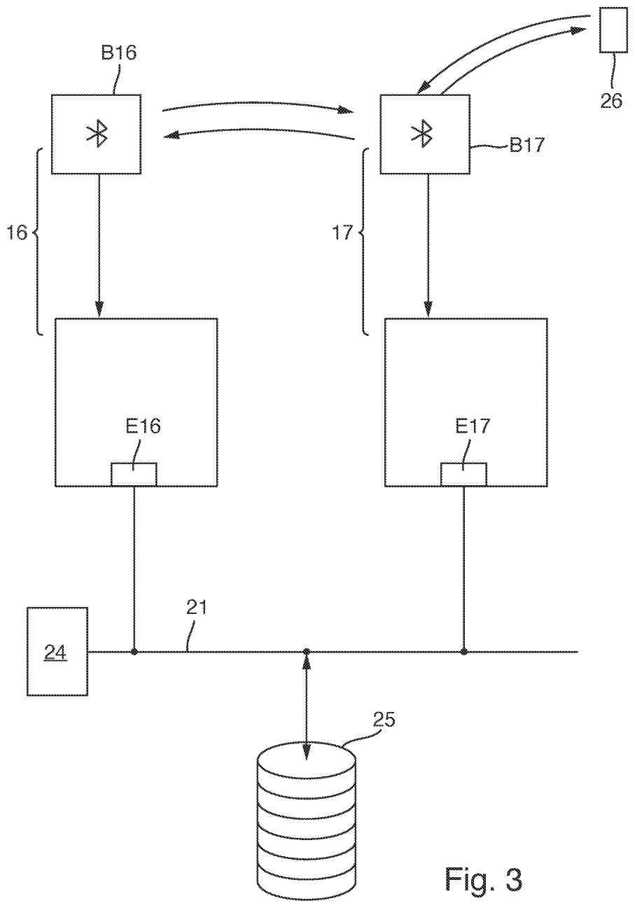

FIG. 3 an illustration of the cooperation of multiple apparatuses with one another and with an external network,

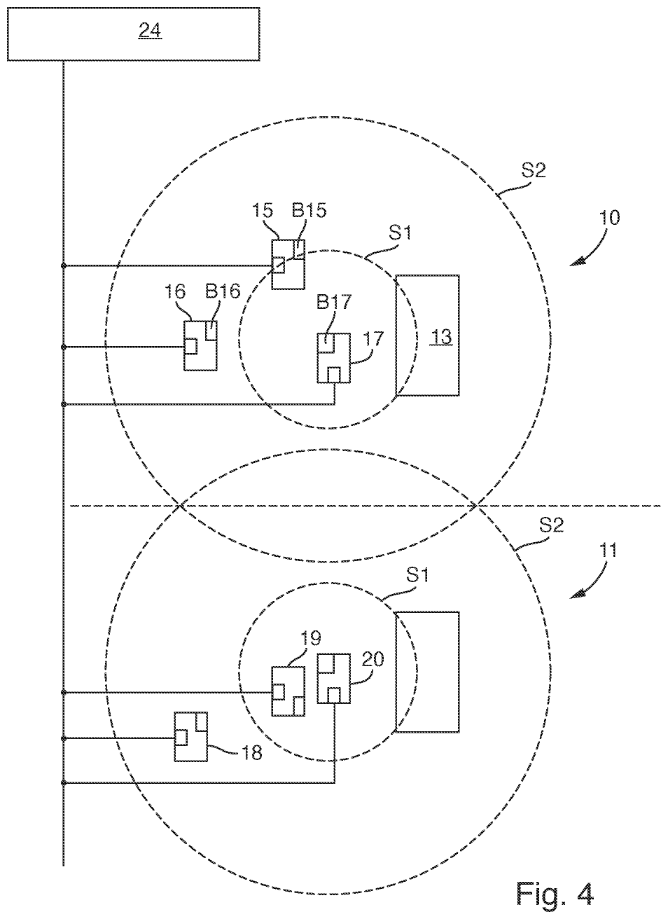

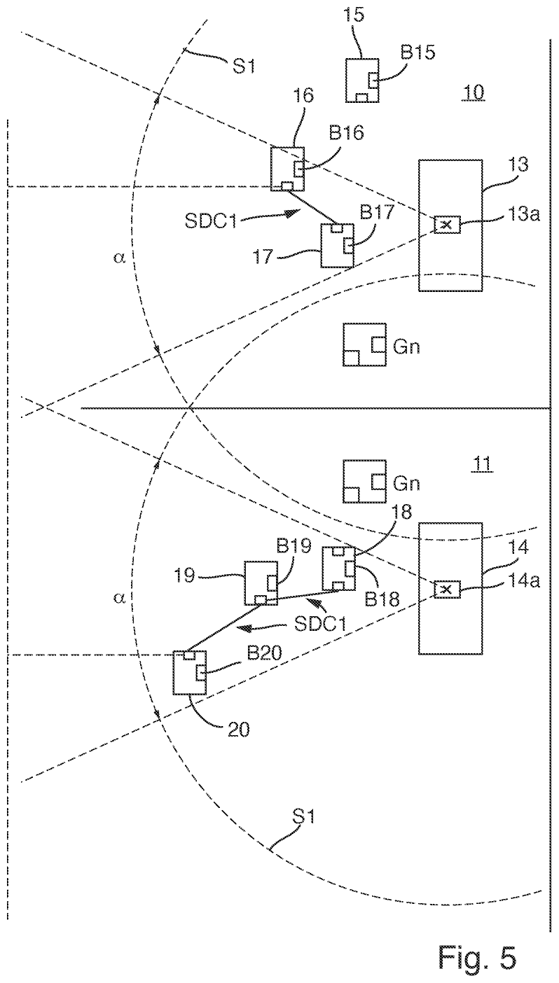

FIGS. 4 and 5 additional embodiments of the apparatus system according to the invention.

In FIG. 1 the schematic situation of two operation environments 10, 11 is illustrated that are established, for example, in a hospital or also in another installation. For example, the two operation environments 10, 11 can be operation rooms that are separated from one another by a wall 12 illustrated in dashed lines in FIG. 1. The wall can be solid and radio wave attenuating or also radio wave transparent.

Each operation environment 10, 11 comprises an operating table 13, 14 as well as multiple apparatuses 15, 16, 17, 18, 19, 20. The apparatuses 15 to 17 are part of the first operation environment 10, while the apparatuses 18 to 20 are part of the second operation environment 11. For example, they serve for supply of instruments prior to, during or after an operation on the patient is/has been carried out, who lies on the operating table 13 and/or 14. The apparatuses 15 to 20 can be configured, for example, to supply suitable fluids (i.e. gases, liquids, aerosols or the like) to the connected instruments, to supply connected instruments with current or voltage in order to cut, coagulate, ablate, fusion tissue by suitable instruments, for example, or any measure of the sort. Also, one or multiple of the apparatuses can be configured to carry out tissue examinations, e.g. by optical emission spectroscopy, impedance spectroscopy, fluid examination or the like. Also, one or more of the apparatuses can be established as central operating apparatuses in order to control other apparatuses. In the present embodiment the apparatuses 7 and 20 are illustrated as central operating apparatuses VIO3.

All apparatuses 15 to 20 can be connected to a network, e.g. a hospital-wide network or also a network with further range that can be entirely or partly wired and/or entirely or partly configured as radio network (LAN, WIFI, WLAN, WAN).

Each of the apparatuses 15 to 20 comprises a first communication device B15 to B20 with short general range. The first communication device B15 to B20 is preferably a wireless communication device that operates by radio waves or light and the general range of which is preferably minimum in the order of the dimension of the operation environment. A general range means the range without range decreasing or range increasing external influences. This general range of the first communication devices is preferably approximately 10 m to 100 m. The first communication device B15 to B20 can be a Bluetooth communication device of class 1, for example, having a general range of approximately 100 m, of class 2 having a general range of approximately 10 m or also class 3 having a general range of approximately 1 m only. In the example illustrated in FIG. 1, the conditions for a first communication device B15 to B20 having a general range of 10 m to 100 m are illustrated. The Bluetooth interface can be configured according to the Bluetooth standard 3.0 or higher.

For establishing the connection to the network 21, each apparatus 15 to 20 comprises a second communication device E15 to E20, which can be, for example, wired communication devices or wireless communication devices, e.g. according to a common standard, for example WIFI or WLAN. The communication devices E15 to E20 are connected to the network 21.

The apparatuses 15, 16, 17 (as well as potentially additional apparatuses Gn, which are not illustrated here and which are part of this operation environment) shall communicate with one another, but not with the apparatuses 18, 19, 20 of the neighboring operation environment 11 (and vice versa). For this purpose, the apparatuses 15, 16, 17 as well as the apparatuses 18, 19, 20 are configured to carry out service-orientated apparatus communication in the respective network 21 on the basis of a manufacturer-independent standard, such as SDC. In so far, they are connected to a subnetwork. For this purpose, the apparatuses 15, 16, 17 as well as 18, 19, 20 are configured to exchange certificates among one another and thus form a subnetwork closed relative to the remaining network 21. The apparatuses 15 to 17 form one cluster, while the apparatuses 18 to 20 form another cluster. The certificate exchange between the apparatuses 15 to 20 is preferably carried out via the first communication devices B15 to B20.

The apparatuses 15 to 20 are configured to only connect to a cluster, if the distance among each other as well as the distance to a central apparatus (here the apparatuses VIO3 17 and VIO3 20) is below a threshold S1, as illustrated in FIG. 1. The threshold S1 is thus a distance limit value that is less than the general range of the first communication devices B15 to B20.

The first communication devices B15 to B20 serve to exchange a key and/or certificate and/or a UUID with those apparatuses B15 to B20, which are within the minimum distance S1. After exchange of this certificate, the apparatuses B15 to B17 as well as B18 to B20 can communicate among one other using network 21 and thus can form a first subnetwork or partial network for the operation environment 10 and a second subnetwork or partial network for the second operation environment 11.

Each apparatus 15 to 20 comprises a control 22. At least in one of the apparatuses 7 and 20, where applicable however also in the other apparatuses, control 22 is connected to a display device 23, for example in form of a screen with operating elements arranged peripherally or also in the form of a touchscreen or the like. The control 22 is in addition connected to the communication devices of the apparatus, in the example according to FIG. 2 to the first communication device 17 and the second communication device E17.

As illustrated in FIG. 2, apparatus 17 can be configured to measure the distance to the other apparatuses 15, 16 as well as to additional apparatuses Gn, if present, by its first communication device B17 and to indicate these apparatuses on the display device 23 before they are embedded in the local network of the operation environment. A distance indication can be contained in the display information. The distance indication can be realized numerically in meters or centimeters or by an analog dimensional illustration, whereby close apparatuses are illustrated larger and far apparatuses are illustrated smaller. The illustration can be symbolic or, as indicated in FIG. 2, can be reduced to appropriately marked boxes. Also other intuitively comprehensible dimensional illustrations can be used, such as the increase of the color contrast of the apparatus symbolization relative to the background with decreasing distance. In the apparatus illustration an input field j/n (yes/no) can be provided, as is further indicated, in order to acknowledge or reject the coupling of the apparatus and thus the certificate exchange.

The presented apparatus system according to FIG. 1 in the simplest embodiment described so far, operates as follows:

The starting point of the description is a situation in which the apparatuses G15 to G17 have been brought in the operation environment 10 and the apparatuses G18 to G20 have been brought in the operation environment 11 according to FIG. 1. After activation of the apparatuses 15 to 17, their controls are first configured to determine the distances to the controlling central apparatus 17 by the first communication device B15 to B17. All apparatuses for which the distance to the apparatus 17 is below the threshold S1 now exchange certificates or keys with one another via the first communication devices B15 to B17 and subsequently form a via network 21 and communicate in encrypted manner in the subnetwork by the certificates or keys. This can be carried out automatically exclusively depending on distance.

However, it is also possible that the apparatuses 15 to 17 exchange their keys only, if this has been confirmed manually. For this purpose, the apparatuses 15 and 16 are first at least symbolically displayed on the screen 23 of apparatus 17 and are there either approved (accepted) or rejected by manual input. In doing so, it is avoided that apparatuses of neighboring operation environments are unintentionally coupled, because the operation environments are located close to one another. If wall 12 in the embodiment according to FIG. 1 is massive, however, the danger of erroneous coupling is largely excluded. It is also possible to define a low threshold S1, so that the apparatuses 15 to 17 have to be brought next to one another up to a few decimeters in order to couple. Such an embodiment avoids the effort of manual confirmation indicated in FIG. 2.

FIG. 3 illustrates a supplement of the system described so far on the basis of the apparatuses 16 and 17 and the inclusion into the network 21, for example a hospital or another operation environment. The network 21 can be a hospital network comprising one or more databases 25 or other suitable data storages, for example. The data storage or database 25 can contain patient data, operation data, operation plans, apparatus settings for a specific operation and/or specific surgeons. The first communication devices B16, B17 serve in turn for a distance measurement between the apparatuses 16, 17.

In addition, at least one of the first communication devices, here the communication device B17, can serve to communicate with a mobile device 26, for example in form of a mobile phone assigned to a surgeon. Thereby also other devices, for example a tablet, a pager, a keycard, a Bluetooth dongle or the like can be used. By the mobile device 26 the surgeon can log in to apparatuses 15 to 17 of its operation environment 10. The apparatus 17 as well as any other apparatus 15, 16 can then be configured to access the database 25 beyond the local subnet being part of the operation environment 10 via the hospital network 21, in order to load surgeon-specific setting data for the apparatuses 15, 16, 17 and to adjust the apparatuses 15, 16, 17 accordingly, for example. Thereby each surgeon finds in a sense his/her preferred settings without being required to adjust all apparatuses manually respectively in a manner desired by him/her, e.g. with regard to mode and effect strength.

The mobile device 26 can also be a device assigned to the patient and thus identifying the patient, which identifies the patient via the first communication device B17 in the selected operation environment. The apparatus subsystem formed by the apparatuses 15, 16, 17 here can in turn access database 25 via network 21 and can, for example, receive data assigned to the patient such as diagnosis, operation plan, etc. and can display them, e.g. on the display device 23. Also, the apparatuses 15 to 17 can be preset in this manner according to the operation plan.

FIG. 4 illustrates a modified embodiment of the invention for which the description above applies on the basis of the already introduced reference signs accordingly. In addition to the description above, it applies that first threshold S1 defining the minimum distance for coupling the apparatuses 15, 16, 17 is complemented by a second threshold S2 defining the maximum distance within which the apparatuses 15, 16, 17 remain coupled with one another. Again, first communication devices B15, B16, B17 serve for measurement of the distance between the apparatus 17 and the other apparatuses 15, 16. The control devices of the apparatuses 15, 16, 17 are configured to enter into communication and thus exchange certificates via the first communication devices B15, B16, B17 only, if the distance is below the first threshold S1. For this reason, the apparatuses 15, 16, 17 have to be brought together at a distance for coupling, which is below the first threshold S1 of, for example, 1 or 2 meters. A manual confirmation according to the example of FIG. 2 can be omitted, if this first threshold S1 is small enough. The apparatuses 15, 17 are in addition configured to maintain the coupling and thus the subnet created by them as long as the distance is not greater than the second threshold S2.

The same applies accordingly for the second operation environment 11. As indicated in FIG. 4, the apparatuses 15, 16, 17 can be freely moved within the radius defined by second threshold S2 without losing the coupling again, once they have been located within the radius defined by first threshold S1. An unintentional coupling of apparatuses of the first operation environment 10 with apparatuses of the second operation environment 11 is, however, excluded because indeed the radii defined by the second thresholds S2 overlap, but not the radii predefined by the first thresholds S1.

In addition or as an alternative to the measures described above, it is also possible to not only exchange distance information, but also direction information. An embodiment for this purpose is schematically indicated in FIG. 5. The particularity of this apparatus system is that apparatus couplers 13a, 14a are assigned to the operating tables 13, 14, wherein the apparatus couplers 13a, 14a are configured to communicate with the first communication devices B15 to B20, if their distance to the apparatus coupler 13a, 14a is less than the threshold S1 and in addition, if the apparatuses 15 to 20 are within an angle α, which is defined by the apparatus coupler 13a or 14a. FIG. 5 illustrates an apparatus Gn, the distance of which to the apparatus couplers 13a, 14a is indeed less than the threshold S1, wherein however it is outside of angle α and thus outside of the coupling sectors defined by the apparatus couplers 13a, 14a. In this position it is not integrated into the subnet SDC1 and also not into the subnet SDC2, which are indicated in FIG. 5 by connection lines between the coupled apparatuses 16, 17; 18, 19, 20 respectively. Also, the apparatus 15 in operation environment 10 is accordingly not coupled.

The system according to an embodiment of the invention can also be used for prioritization of messages. Thereby the control of the apparatuses can be configured so that the smaller the distance between the apparatuses, the higher the priority of the messages. Based on the priority, the visibility on an endoscopic system can be increased, for example.

The system suitable for prioritization of apparatuses 15 to 20 can also be used for system configuration. For example, if a physician is present in a position that has been defined previously, e.g. an operating table, a previously stored configuration can be automatically activated, e.g. with regard to the modes or effect settings. The position of the physician can be detected then by a Bluetooth dongle or a smartphone, which the physician carries, for example.

In addition, the apparatuses 15 to 20 of the system can be configured to take defined system conditions upon detection of compatible apparatuses. For example, if an apparatus for Optical Emission Spectroscopy (OES) and an apparatus VIO3 are detected via Bluetooth, i.e. the first communication device, in the proximity and if both apparatuses are in the same network SDC1 or SDC2, the best mode and effect for tissue identification by optical emission spectroscopy can be set automatically at an apparatus for electrical supply of an instrument.

The apparatus system according to an embodiment of the invention allows an automatic pairing of different apparatuses 15-20 within different operation environments 10, 11. The pairing is carried out based on signal strength or indoor navigation (e.g. Bluetooth 5). It is detected whether a communication partner, i.e. another apparatus 15-20, is present in a distance within a predefined radius S1 from any other apparatus or from a central apparatus 17, 20. During the detection the pairing is initiated automatically by UUID or certificate exchange without additional interaction by the user or with simple confirmation by the user.

1. A method for establishing a data connection between at least two apparatuses in an operation environment, wherein each of the apparatuses in the operation environment respectively comprises at least one communication device, wherein at least one of the communication devices is a wireless communication device, the method comprising:
determining the distance between the at least two apparatuses) by one of the communication devices; and
allowing an integration of the respective apparatus to a subnetwork (SDC1) if the distance between the apparatuses is below a first threshold (S1).

2. The method according to claim 1, wherein one of the apparatuses or an apparatus coupler is immovably arranged to form a fixed reference point to measure the distance of the other apparatuses relative to the fixed reference point.

3. The method according to claim 1, further comprising the step of terminating the communication connection to the subnetwork (SDC1) if the distance exceeds a second threshold (S2).

4. The method according to claim 1, wherein the second threshold (S2) is equal or higher than the first threshold (S1).

5. The method according to claim 2, further comprising the step of the apparatus coupler determining the angular range between the apparatuses.

6. The method according to claim 5, further comprising the step of establishing a communication connection between the apparatus and a subnetwork (SDC1) only if the apparatus is within a predefined angular range (a).

7. The method according to claim 1, further comprising the step of displaying the at least one apparatus on the other of the at least two apparatuses.

8. The method according to claim 1, further comprising the step of establishing a connection between the apparatus and a subnetwork (SDC1) only after clearance has been given on the apparatus on which it has been displayed.

9. The method according to claim 1, wherein
the at least one apparatus comprises a first communication device having a first range; and
the other of the at least two apparatuses has a second communication device having a second range that is larger than the first range of the first communication device,
wherein the communication connection between the at least one apparatus and the other of the at least one apparatus is integrated onto a subnetwork (SDC1) carried out by the second communication devices.

10. An apparatus system having at least two apparatuses in an operation environment, wherein each of the apparatuses in the operation environment respectively comprises:
at least one communication device, wherein at least one of the communication devices is a wireless communication device,
wherein the apparatuses are configured to determine the distance between the apparatuses by their respective communication devices and
wherein at least one of the communication devices is configured to establish a communication connection to a subnetwork (SDC1), if the distance is below a first threshold (S1).

11. The apparatus system according to claim 10, wherein one of the apparatuses is an apparatus coupler immovably installed in the operation environment.

12. The apparatus system according to claim 11, wherein a first communication device having a general range between 1 m and 100 m and a second communication device having a larger range is part of at least one of the communication devices of at least one apparatus.

13. The apparatus system according to claim 12, wherein at least one of apparatus comprises a display device configured to determine whether the distance of the at least one apparatus or apparatus coupler is below a threshold (S1).

14. The apparatus system according to claim 13, wherein an input device is provided that is configured to give clearance for the apparatuses displayed by the display device for establishing a communication connection to the subnetwork (SDC1).

15. The apparatus system according to claim 14, wherein the subnetwork (SDC1) can be connected to a database via the network.
